(19) United States
(12) Patent Application Publication
(10) Pub. No.: US 2019/0121370 A1
(43) Pub. Date: Apr. 25, 2019

(54) APPROACH SYSTEM FOR AUTONOMOUS UNDERWATER VEHICLE APPROACHING UNDERWATER FACILITY

(71) Applicant: KAWASAKI JUKOGYO KABUSHIKI KAISHA, Kobe-shi, Hyogo (JP)

(72) Inventors: Hiroshi SAKAUE, Kobe-shi (JP); Minehiko MUKAIDA, Kobe-shi (JP); Noriyuki OKAYA, Kobe-shi (JP); Takashi OKADA, Kobe-shi (JP); Fumitaka TACHINAMI, Kobe-shi (JP)

(73) Assignee: KAWASAKI JUKOGYO KABUSHIKI KAISHA, Kobe-shi, Hyogo (JP)

(21) Appl. No.: 16/090,499

(22) PCT Filed: Mar. 23, 2017
(86) PCT No.: PCT/JP2017/011765

§ 371 Date: Oct. 1, 2018

(30) Foreign Application Priority Data
Mar. 31, 2016 (JP) 2016-071625

(51) Int. Cl. G05D 1/08; B63G 8/00; B63G 8/39; B63G 8/38; G01S 3/782; G01S 3/808

(52) U.S. Cl. CPC G05D 1/0875; B63G 8/001; B63G 8/39; B63G 2008/004; G01S 3/782; G01S 3/8083; B63G 2008/008; B63G 8/38

(57) ABSTRACT

An approach system for an autonomous underwater vehicle approaching an underwater facility includes: an underwater facility located in water and including a light emitter configured to radially emit light; and an autonomous underwater vehicle including an underwater vehicle main body and a light receiving array provided at the underwater vehicle main body and including a plurality of light receiving elements that are independent from one another.

### TECHNICAL FIELD

The present invention relates to an approach system for an autonomous underwater vehicle approaching an underwater facility, such as an underwater station.

### BACKGROUND ART

Utilized for seabed work, seabed investigation, and the like is an autonomous underwater vehicle (hereinafter may be referred to as an “AUV”) which does not require electric power supply from a mother ship and sails in water by a built-in power source. Proposed as such AUV is an AUV configured to receive a power source from an underwater facility located in water. In order that the AUV approaches the underwater facility, the AUV needs to approach the underwater facility while recognizing the position of the underwater facility. Known as a method by which the AUV approaches the underwater facility is a method utilizing acoustic positioning.

For example, PTL 1 discloses that: the underwater station is provided with an ultrasonic transmitter, and the AUV is provided with a sonar; the sonar of the AUV receives a sound wave transmitted from the ultrasonic transmitter; and the AUV enters the underwater station while measuring its position relative to the underwater station.

### CITATION LIST

### Patent Literature

PTL 1: Japanese Laid-Open Patent Application Publication No. 2000-272583

### SUMMARY OF INVENTION

### Technical Problem

When the sonar of the AUV and the ultrasonic transmitter of the underwater station are located close to each other, the AUV cannot accurately specify an incoming direction of the sound wave from the ultrasonic transmitter. Therefore, in PTL 1, the ultrasonic transmitter and a capturing member configured to capture the AUV are separately arranged at the underwater station so as to be located at AUV entering direction far and near sides, respectively, and the capturing member is formed in a V shape that narrows from an AUV entering side toward a tip end of the capturing member to absorb a deviation of an entering angle of the AUV. However, when the underwater facility needs a solution to the deviation of the approaching of the AUV as above, the configuration of the underwater facility becomes complex. Therefore, a system for making the AUV accurately approach the underwater facility is desired.

In this regard, PTL 1 also discloses that: the AUV is provided with a TV camera; and the position and direction of the underwater station are confirmed by image recognition. When the AUV is made to approach the underwater station by image recognition processing, the AUV can be made to accurately approach the underwater facility. However, since the AUV requires a processing unit configured to execute the image recognition processing, the configuration of the AUV becomes complex.

An object of the present invention is to provide an approach system for an AUV approaching an underwater facility, the approach system being simple and capable of making the AUV accurately approach the underwater facility.

### Solution to Problem

To solve the above problems, an approach system for an AUV approaching an underwater facility according to the present invention includes: an underwater facility located in water and including a light emitter configured to radially emit light; and an AUV including an underwater vehicle main body, and a light receiving array provided at the underwater vehicle main body and including a plurality of light receiving elements that are independent from one another.

According to the above configuration, the light reception sensitivities of the plurality of light receiving elements provided at the underwater vehicle main body when the light receiving elements receive the light from the light emitter differ depending on the positions of the light receiving elements. Therefore, the direction of the underwater facility with respect to the AUV can be detected by comparing the light reception sensitivities of the light receiving elements with one another. On this account, the AUV can be made to accurately approach the underwater facility by the simple system which does not require image recognition processing.

In the approach system for the AUV approaching the underwater facility, the light receiving array may include an attaching portion formed in a convex spherical shape, the plurality of light receiving elements being attached to the attaching portion. According to this configuration, the attaching portion is formed in a convex spherical shape. Therefore, by attaching the light receiving elements to the surface of the attaching portion in the same manner, the light receiving elements are provided such that the light receiving element located at the peripheral edge side of the light receiving array faces the peripheral edge side of the light receiving array. On this account, the detectable angular range in which the light receiving array can detect the light can be enlarged by the simple configuration.

In the approach system for the AUV approaching the underwater facility, the light emitter may emit the light as an optical wireless signal, and the AUV may further include a controller configured to perform signal processing of the optical wireless signal received by the light receiving array. According to this configuration, large data can be transmitted from the underwater facility to the AUV by the optical wireless communication in a short period of time. Further, the light emitter and the light receiving array also serve as an optical wireless communication system for the optical wireless communication from the underwater facility to the AUV. Therefore, at the AUV, it is unnecessary to additionally provide an optical wireless communication system for the optical wireless communication with the underwater facility. On this account, a space in the underwater vehicle main body can be efficiently utilized.

In the approach system for the AUV approaching the underwater facility, the underwater facility may include a transponder configured to transmit an acoustic signal, and the autonomous underwater vehicle may include an acoustic positioning device configured to specify a direction of the underwater facility based on the acoustic signal from the transponder. According to this configuration, the acoustic positioning device specifies the direction of the underwater facility based on the acoustic signal from the transponder. Therefore, in a range in which the light from the light emitter of the underwater facility does not reach, the AUV can be guided to the underwater facility by the acoustic positioning.

### Advantageous Effects of Invention

According to the present invention, the AUV can be made to accurately approach the underwater facility by the simple system.

### BRIEF DESCRIPTION OF DRAWINGS

FIG. 1 is a diagram showing a schematic configuration of an approach system according to one embodiment of the present invention, the approach system being for an AUV approaching an underwater facility.

FIG. 2 is an enlarged perspective view of a light receiving array of the AUV shown in FIG. 1.

FIG. 3 is a diagram showing one example of a relation between a direction of a light receiving element and an incoming direction of light from the underwater facility in the approach system shown in FIG. 1.

FIG. 4 is a schematic side view for explaining the approach system shown in FIG. 1.

FIG. 5 is a schematic top view for explaining the approach system shown in FIG. 1.

FIG. 6 is a diagram showing one example of a relation between the direction of the light receiving element and the incoming direction of the light from the underwater facility in the approach system according to Modified Example.

### DESCRIPTION OF EMBODIMENTS

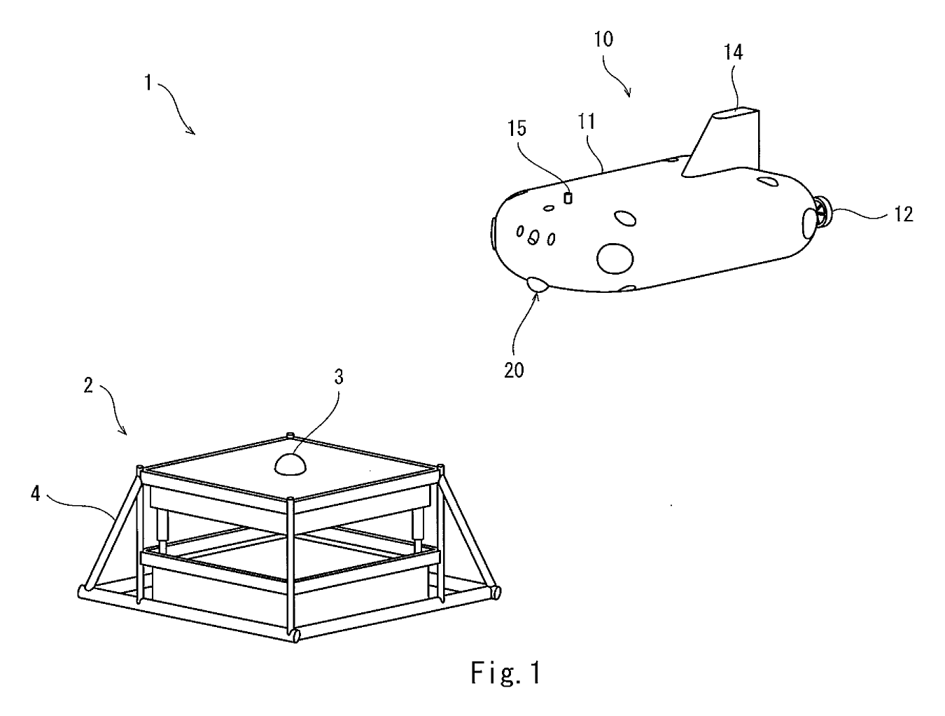

Hereinafter, an embodiment of the present invention will be explained with reference to the drawings. FIG. 1 is a diagram showing a schematic configuration of an approach system 1 for an AUV 10 approaching an underwater facility 2 (hereinafter referred to as an “approach system 1”) according to the embodiment. The approach system 1 makes the AUV 10, sailing in water, approach the underwater facility 2 located in water.

In the present embodiment, the underwater facility 2 is an underwater station capable of docking with the AUV 10 and including a capturing mechanism (not shown) configured to capture the AUV 10. The underwater facility 2 is configured to be able to supply a power source to the AUV 10 in a state where the underwater facility 2 docks with the AUV 10. The underwater facility 2 includes a base 3 provided on the seabed. For example, the underwater facility 2 is connected to a land facility through a cable (not shown) and is configured to be able to receive electric power from the land facility and transmit and receive data to and from the land facility.

The underwater facility 2 is provided with a light emitter 3 configured to radially emit light in 360 degrees over the entire circumference. In the present embodiment, the light emitter 3 has a substantially semi-spherical shape and is provided on a horizontal upper surface of the base 4 so as to be convex upward. For example, the light emitter 3 is configured such that LED substrates are arranged in a semi-spherical transparent casing made of acryl.

In the present embodiment, to perform optical wireless communication between the underwater facility 2 and the AUV 10, the light emitter 3 is configured to be able to emit an optical wireless signal to the AUV 10. Specifically, the light emitter 3 is configured to be able to blink the light emitted therefrom to cause the light to deliver information.

The base 11 of the underwater facility 2 is provided with a transponder (not shown) configured to transmit an acoustic signal.

Next, the configuration of the AUV 10 will be explained. In the following explanation, a sailing direction in which the AUV 10 sails is defined as a front side, and a direction opposite to the sailing direction is defined as a rear side. A left side when facing the sailing direction is defined as a left side, and a right side when facing the sailing direction is defined as a right side. An upper side when facing the sailing direction is defined as an upper side, and a lower side when facing the sailing direction is defined as a lower side.

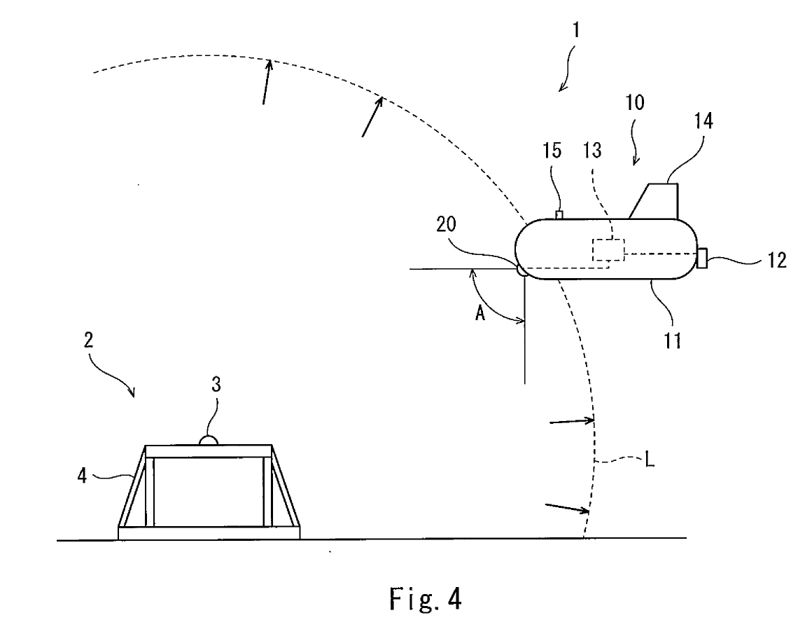

The AUV 10 includes: an underwater vehicle main body 11 incorporating a storage battery as a power source; and some propulsion devices 12 (only one propulsion device 12 is shown in the drawings), such as propellers, configured to generate propulsive force for sailing in water. The AUV 10 includes a controller 13 (see FIG. 4) provided in the underwater vehicle main body 11 and configured to control the propulsion device 12. The AUV 10 autonomously sails in accordance with a program held by the controller 13. A front portion of the underwater vehicle main body 11 has a streamline shape that is low in water resistance. A vertical wing 14 configured to define horizontal posture of the AUV 10 is provided at a rear side of an upper portion of the underwater vehicle main body 11.

An acoustic positioning device 15 is provided at the upper portion of the underwater vehicle main body 11. The acoustic positioning device 15 and the transponder of the underwater facility 2 constitute an acoustic positioning system configured to specify a distance from the underwater facility 2 to the AUV 10 and a direction of the AUV 10 with respect to the underwater facility 2. The acoustic positioning system is, for example, a SSBL (Super Short Base Line) positioning system configured such that: a distance to the transponder is calculated from a time until when the acoustic signal from the transponder is received; and a direction is calculated based on a phase difference of sound waves which have reached respective elements of a wave receiving array included in the acoustic positioning device 15. It should be noted that the acoustic positioning system does not have to be the SSBL system and may be a LBL (Long Base Line) system, a SBL (Short Base Line) system, or the like.

A light receiving array 20 is provided at a front side of a lower portion of the underwater vehicle main body 11. The light receiving array 20 detects the direction of the underwater facility 2 with respect to the AUV 10 by receiving the light coming in from the light emitter 3. According to the acoustic positioning system, when the acoustic positioning device 15 of the AUV 10 and the transponder of the underwater facility 2 are located close to each other, the acoustic positioning device 15 cannot accurately specify an incoming direction of the acoustic signal from the transponder. Therefore, when the distance from the underwater facility 2 to the AUV 10 is a middle or long distance, the AUV 10 approaches the underwater facility 2 based on the acoustic positioning. When the distance from the underwater facility 2 to the AUV 10 is a short distance, the AUV 10 approaches the underwater facility 2 by using the light receiving array 20.

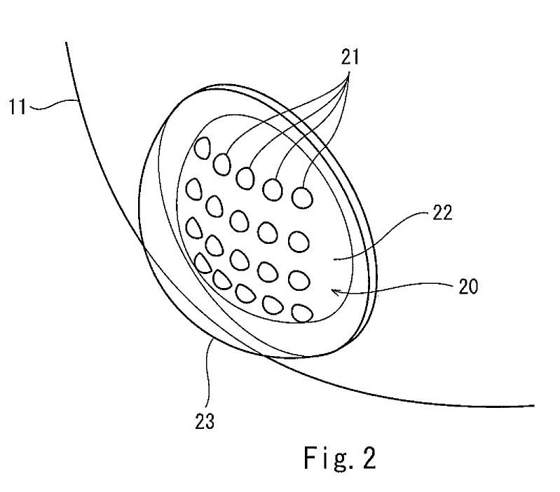

FIG. 2 is an enlarged perspective view of the light receiving array 20. The light receiving array 20 includes: a plurality of light receiving elements 21 that are independent from one another; and an attaching portion 22 to which the plurality of light receiving elements 21 are attached. The light receiving array 20 is covered with a cover 23 provided at the underwater vehicle main body 11. The cover 23 is a member having high optical transparency and is made of, for example, colorless and transparent acryl.

The plurality of light receiving elements 21 have common directional characteristics. Hereinafter, a direction in which light reception sensitivity of the light receiving element 21 is maximized is referred to as “a direction in which the light receiving element faces.” In the present embodiment, the light receiving elements 21 are photodiodes. The light receiving elements may be, for example, photo multipliers instead of the photodiodes. The plurality of light receiving elements 21 are arranged on the attaching portion 22 at predetermined intervals. The attaching portion 22 is formed in a convex spherical shape. Each of the light receiving elements 21 is provided on the attaching portion 22 so as to face a normal direction of a surface to which the light receiving element 21 is attached. The light receiving element 21 located at a peripheral edge side of the light receiving array 20 faces the peripheral edge side of the light receiving array 20. A peripheral edge of the attaching portion 22 is annular, and a center line of the attaching portion 22 extends between a proceeding direction of the underwater vehicle main body 11 and a lower direction of the underwater vehicle main body 11. In the present embodiment, as shown in FIG. 2, the plurality of light receiving elements 21 are arranged in a lattice pattern on the attaching portion 22. However, the arrangement of the plurality of light receiving elements 21 is not limited to this. For example, the plurality of light receiving elements 21 may be arranged in an annular pattern about a top portion of the attaching portion 22.

The light received by the light receiving element 21 is converted into an electric signal, and the electric signal is transmitted to the controller 13. The light reception sensitivities of the plurality of light receiving elements 21 when the light receiving elements 21 receive the light from the light emitter 3 differ depending on the positions of the light receiving elements 21. Therefore, the controller 13 detects the direction of the underwater facility 2 with respect to the AUV 10 by comparing the light reception sensitivities of the light receiving elements 21 with one another.

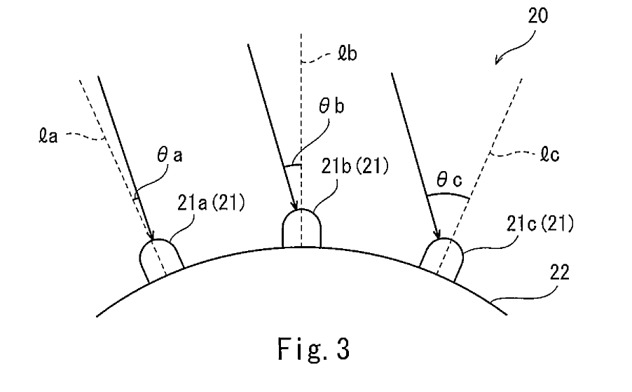

Hereinafter, the detection of the direction of the underwater facility 2 by using the light receiving array 20 will be explained in detail with reference to FIG. 3. FIG. 3 is a diagram showing one example of a relation between the direction of the light receiving element 21 and the incoming direction of the light from the underwater facility 2. In FIG. 3, only three light receiving elements 21a, 21b, and 21c lined up in a row are shown among the plurality of light receiving elements 21 included in the light receiving array 20. Further, in FIG. 3, directions in which the light receiving elements 21a, 21b, and 21c face are shown by respective broken lines 1a, 1b, and 1c, and the incoming direction of the light is shown by arrows.

According to the directional characteristics of the light receiving elements 21, the light reception sensitivity of the light receiving element 21 (i.e., an output of the light receiving element 21) increases as an angle formed by the incoming direction of the light from the light emitter 3 and the direction in which the light receiving element 21 faces decreases. In the example shown in FIG. 3, a relation among an angle θa between the incoming direction of the light and the direction 1a in which the light receiving element 21a faces, an angle θb between the incoming direction of the light and the direction 1b in which the light receiving element 21b faces, and an angle θc between the incoming direction of the light and the direction 1c in which the light receiving element 21c faces is represented by θa<θb<θc. Therefore, among the three light receiving elements 21a, 21b, and 21c, the output of the light receiving element 21a is the highest, and the output of the light receiving element 21c is the lowest. Based on a distribution of the outputs from the light receiving elements 21a, 21b, and 21c, the controller 13 determines that the light emitter 3 is located in a direction from a center of the light receiving array 20 toward the light receiving element 21a whose output is the highest. Then, the controller 13 controls the propulsion device 12 such that the AUV 10 accurately approaches the underwater facility 2.

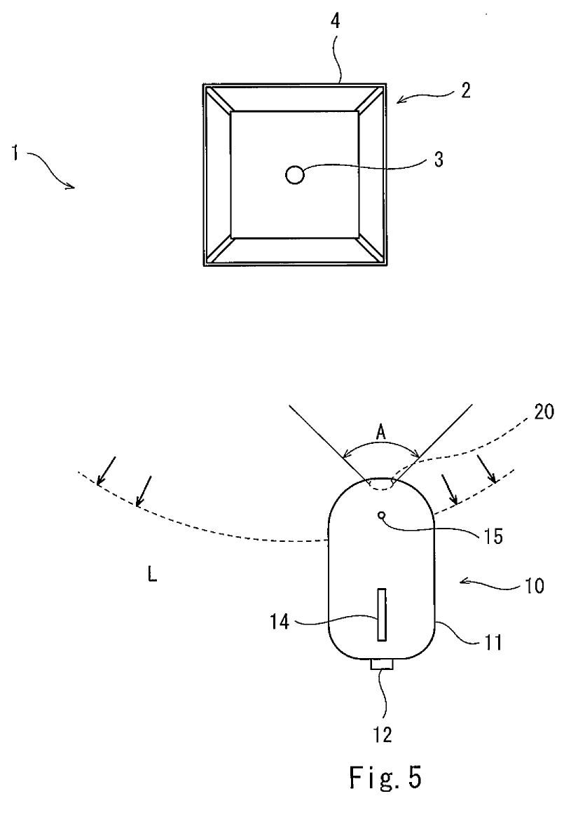

FIG. 4 is a schematic side view of the approach system 1. FIG. 5 is a schematic top view of the approach system 1. Each of FIGS. 4 and 5 shows a state where the AUV 10 has approached the underwater facility 2 by the acoustic positioning and has entered a region L in which the light from the light emitter 5 reaches the light receiving array 20. For example, when the distance from the AUV 10 to the underwater facility 2 measured by the acoustic positioning becomes not more than a predetermined distance (for example, 10 meters) that is a distance within the range L in which the light from the light emitter 3 reaches the light receiving array 20, the controller 13 switches from the approaching by the acoustic positioning to the approaching by using the light receiving array 20. Or, the controller 13 may switch from the approaching by the acoustic positioning to the approaching by using the light receiving array 20 when the output from the light receiving element 21 exceeds a predetermined threshold.

A detectable angular range A in which the light receiving array 20 can detect the light is determined based on the directional characteristics of the light receiving elements 21, the number of light receiving elements 21, an interval between the adjacent light receiving elements 21, the curvature of the attaching portion 22, and the like. In the present embodiment, the plurality of light receiving elements 21 are arranged at the attaching portion 21 such that each of the detectable angular range A in the upper-lower direction and the detectable angular range A in the left-right direction has approximately 90 degrees about the light receiving array 20. It should be noted that the light receiving array 20 may be designed such that the detectable angular range A in the upper-lower direction and the detectable angular range in the left-right direction are different from each other.

As described above, to perform the optical wireless communication between the underwater facility 2 and the AUV 10, the light emitter 3 of the underwater facility 2 can emit the optical wireless signal, and the controller 13 of the AUV 10 performs signal processing of the optical wireless signal transmitted from the light emitter 3 to the light receiving array 20. For example, the optical wireless communication is started when the acoustic signal serving as a trigger for the start of the optical wireless communication is transmitted from the AUV 10 to the underwater facility 2. Examples of the information transmitted from the underwater facility 2 to the AUV 10 by the optical wireless signal include: command information transmitted from the land facility to the underwater facility 2 for the AUV 10; and observation data obtained by a measuring device, such as a seismometer, provided at the underwater facility 2.

As explained above, in the approach system 1 of the present embodiment, the light reception sensitivities of the plurality of light receiving elements 21 when the light receiving elements 21 receive the light from the light emitter 5 differ depending on the positions of the light receiving elements 21. Therefore, the direction of the underwater facility 2 with respect to the AUV 10 can be detected by comparing the light reception sensitivities of the light receiving elements 21 with one another. On this account, the AUV 10 can be made to accurately approach the underwater facility 2 by the simple system which does not require image recognition processing.

Further, in the present embodiment, the attaching portion 22 is formed in a convex spherical shape. Therefore, by attaching the light receiving elements 21 to the surface of the attaching portion 22 in the same manner, the light receiving elements 21 are provided such that the light receiving element 21 located at the peripheral edge side of the light receiving array 20 faces the peripheral edge side of the light receiving array 20. On this account, the detectable angular range A in which the light receiving array 20 can detect the light can be enlarged by the simple configuration.

Further, in the present embodiment, the light emitter 3 emits the optical wireless signal, and the controller 13 performs the signal processing of the optical wireless signal received by the light receiving array 20. Therefore, large data can be transmitted from the underwater facility 2 to the AUV 10 by the optical wireless communication in a short period of time. Further, the light emitter 3 and the light receiving array 20 also serve as an optical wireless communication system for the optical wireless communication from the underwater facility 2 to the AUV 10. Therefore, at the AUV 10, it is unnecessary to additionally provide an optical wireless communication system for the optical wireless communication with the underwater facility 2. On this account, a space in the underwater vehicle main body 11 can be efficiently utilized.

Further, in the present embodiment, the acoustic positioning device 15 specifies the direction of the underwater facility 2 based on the acoustic signal from the transponder of the underwater facility 2. Therefore, in a range in which the light from the light emitter 5 of the underwater facility 2 does not reach, the AUV 10 can be guided to the underwater facility 2 by the acoustic positioning.

The present invention is not limited to the above embodiment, and various modifications may be made within the scope of the present invention.

For example, the directional characteristics of the light receiving elements 21, the number of light receiving elements 21, the interval between the adjacent light receiving elements 21, the curvature of the attaching portion 22, and the like are suitably selected in accordance with approach accuracy required for the approach system 2 and the detectable angular range A of the light receiving array 20.

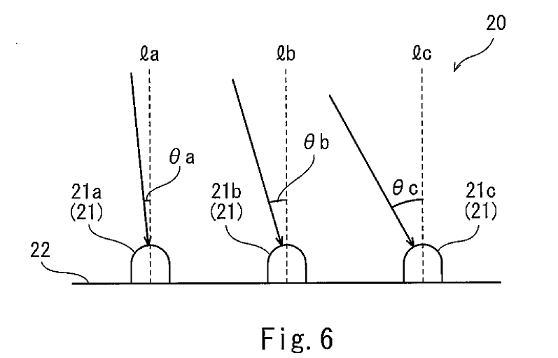

Further, in the above embodiment, the attaching portion 22 of the light receiving array 20 is formed in a convex spherical shape. However, for example, the attaching portion 22 of the light receiving array 20 may have a planar shape or a convex polyhedral shape. FIG. 6 shows one example of a relation between the direction of the light receiving element 21 and the incoming direction of the light from the underwater facility 2 when the attaching portion 22 has the planar shape. As with FIG. 3, in FIG. 6, only three light receiving elements 21a, 21b, and 21c lined up in a row are shown among the plurality of light receiving elements 21 included in the light receiving array 20. In the example shown in FIG. 6, a relation among an angle θa between the incoming direction of the light and the direction 1a in which the light receiving element 21a faces, an angle θb between the incoming direction of the light and the direction 1b in which the light receiving element 21b faces, and an angle θc between the incoming direction of the light and the direction 1c in which the light receiving element 21c faces is represented by θa<θb<θc. Therefore, among the three light receiving elements 21a, 21b, and 21c, the output of the light receiving element 21a is the highest, and the output of the light receiving element 21c is the lowest. Even in this case, the direction of the underwater facility 2 with respect to the AUV 10 can be detected by comparing the light reception sensitivities of the light receiving elements 21 with one another. On this account, the AUV 10 can be made to approach the underwater facility 2 by the simple system which does not require image recognition processing.

Further, in the above embodiment, the underwater facility 2 is an underwater installation type provided on the seabed. However, the underwater facility 2 may be an underwater movement type configured to move in water by, for example, being towed by a ship on the sea. Furthermore, the underwater facility 2 does not have to be configured to dock with the AUV 10.

Further, in the above embodiment, one light receiving array 20 is provided at the underwater vehicle main body 11. However, a plurality of light receiving arrays 20 may be provided at the underwater vehicle main body 11. For example, in addition to the light receiving array 20 of the above embodiment, two more light receiving arrays 20 may be provided at respective right and left sides of the underwater vehicle main body 11.

Further, in the above embodiment, the controller 13 configured to control the propulsion device 12 executes the comparison of the light reception sensitivities of the light receiving elements 21 and the signal processing of the optical wireless signal. However, the above embodiment is not limited to this. The control of the propulsion device 12, the comparison of the light reception sensitivities of the light receiving elements 21, and the signal processing of the optical wireless signal may be performed by different controllers.

### REFERENCE SIGNS LIST

1 approach system
2 underwater facility
3 light emitter
10 AUV (autonomous underwater vehicle)
11 underwater vehicle main body
13 controller
15 acoustic positioning device
20 light receiving array
21 light receiving element
22 attaching portion

1. An approach system for an autonomous underwater vehicle approaching an underwater facility,
the approach system comprising:
an underwater facility located in water and including a light emitter configured to radially emit light; and
an autonomous underwater vehicle including
an underwater vehicle main body, and
a light receiving array provided at the underwater vehicle main body and including a plurality of light receiving elements that are independent from one another.

2. The approach system according to claim 1, wherein the light receiving array includes an attaching portion formed in a convex spherical shape, the plurality of light receiving elements being attached to the attaching portion.

3. The approach system according to claim 1, wherein:
the light emitter emits the light as an optical wireless signal; and
the autonomous underwater vehicle further includes a controller configured to perform signal processing of the optical wireless signal received by the light receiving array.

4. The approach system according to claim 1, wherein:
the underwater facility includes a transponder configured to transmit an acoustic signal; and
the autonomous underwater vehicle includes an acoustic positioning device configured to specify a direction of the underwater facility based on the acoustic signal from the transponder.
